(19) United States
(12) Patent Application Publication
(10) Pub. No.: US 2004/0163260 A1
(43) Pub. Date: Aug. 26, 2004

(54) Reciprocating type electric shaver

(75) Inventor: Hiromi Uchiyama, Matsumoto (JP)

Correspondence Address: KODA & ANDROLIA, 2029 CENTURY PARK EAST, SUITE 1430, LOS ANGELES, CA, 90067-3024, US

(73) Assignee: IZUMI PRODUCTS COMPANY

(21) Appl. No.: 10/783,344

(22) Filed: Feb. 20, 2004

(30) Foreign Application Priority Data
Feb. 24, 2003 (JP) 2003-46099

(51) Int. Cl. B26B 19/02

(52) U.S. Cl. 30/43.92; 30/346.51

(57) ABSTRACT

A reciprocating type electric shaver including an outer cutter, an inner cutter in which a plurality of cutter blades that make sliding contact with the inside surface of the outer cutter are disposed on a cutter blade supporting body in a straight row in the direction of length of the outer cutter, and a driving mechanism that causes the inner cutter to make a reciprocating motion in the direction of length of the outer cutter; wherein the outer cutter is formed so as to deform into a curved shape such as a convex shape that protrudes outward or a concave shape that protrudes inward, and the cutter blade supporting body is formed so as to bend into a curved shape in conformity with the outer cutter.

### BACKGROUND OF THE INVENTION

1. Field of the Invention

The present invention relates to a reciprocating type electric shaver and more particularly relates to a reciprocating type electric shaver in which the outer surface of the outer cutter is deformable into a curved shape in accordance with the pressing pressure applied during shaving.

2. Prior Art

FIG. 9(a) shows the outer cutter portion of a conventional reciprocating type electric shaver, and FIG. 9(b) shows the construction of the inner and outer cutters of this conventional reciprocating type electric shaver.

The outer cutter 10 is made of a thin metal plate in which hair introduction holes are formed. A thin metal plate is bent into an inverted U shape (when viewed from the side) and is mounted so that the outer surface is exposed from the upper part of the main body 5 of the electric shaver.

Meanwhile, as shown in FIG. 9(b), the inner cutter 12 is disposed so that this cutter makes a reciprocating motion in the direction of length of the outer cutter 10 (or sideways in FIG. 9(b)) inside the outer cutter 10. In this inner cutter 12, a plurality of cutter blades 14 are disposed in a straight row at specified intervals on a cutter blade supporting body 13 which is disposed parallel to the direction of length of the outer cutter 10. The upper end edges of the cutter blades 14 are in the shape of a circular arc (when viewed from the side) with the same curvature as the inside surface of the outer cutter 10, so that hair is cut between the outer cutter 10 and the cutters formed on the upper end edges of the cutter blades 14 when the cutter blade supporting body 13 makes a reciprocating motion.

In FIG. 9(b), the reference numeral 16 indicates a reciprocating drive shaft which is connected to the central portion of the undersurface of the cutter blade supporting body 13. This reciprocating drive shaft 16 is connected to a driving motor (not shown) installed in the main body 5 of the electric shaver via a conversion mechanism that converts the rotational motion of the output shaft of the driving motor into a rectilinear reciprocating motion. The cutter blade supporting body 13 on which the cutter blades 14 are provided is thus reciprocated by the reciprocating drive shaft 16.

The cutter blade supporting body 13 provided on the upper portion of the reciprocating drive shaft 16 is pushed by a spring (not shown) so that the cutter blade supporting body 13 is urged in a direction that causes this supporting body 13 to come into contact with the outer cutter 10. When the pressing force is applied during shaving, the outer cutter 10 and inner cutter 12 make a “floating” motion, thus moving up and down. The cutter blade supporting body 13 is supported on the reciprocating drive shaft 16 by a shaft 18, so that the outer cutter 10 and the inner cutter 12 tilt about the shaft 18.

The above-described conventional structure or the similar structure thereof can be seen in, for instance, Japanese Patent Application Laid-Open (Kokai) No. H11-19344.

In a reciprocating type electric shaver, as described above, the inner cutter 12 makes a reciprocating motion while making sliding contact with the inside surface of the outer cutter 10, and the outer cutter 10 is provided in a “floating” fashion via the inner cutter 12. As a result, when the cheeks, jaw, neck, etc. are shaved, the outer cutter 10 floats (that is moves up and down) and tilts in accordance with the softness of the skin and angle, etc. at the shaving position, so that shaving is performed with the outer cutter 10 conforming to the skin.

However, the outer cutter 10 of a conventional reciprocating type electric shaver typically shown in FIGS. 9(a) and 9(b) is formed by bending a thin metal plate into an inverted U-shape, and both ends of this bent plate are fixed; as a result, deformation that bends the outer surface of the outer cutter 10 into a concave or convex shape tends not to occur. The reasons for this is that the metal plate that forms the outer cutter 10 is formed to a specified thickness by electro-casting and has a specified strength so as to show sufficient durability even in the case of rubbing against the inner cutter 12, the rigidity increases when the metal plate of this plate is bent into an inverted U-shape, so that the outer cutter 10 has a shape that is free of bending or deformation even when a pressure or an external force is applied to the outer cutter 10. Moreover, the cutter blade supporting body 13 of the inner cutter 12 that makes sliding contact with the outer cutter 10 is provided so that deformation such as bending, etc., tends not to occur.

Accordingly, in the conventional reciprocating type electric shaver, even in cases where the outer cutter 10 floats and/or tilts, the top portion of the outer cutter 10 remains in a rectilinear shape when viewed from the front (as seen in FIG. 9(a)), so that the outer cutter 10 is raised and lowered while keeping its rectilinear shape. Accordingly, even in cases where portions of the face that are curved in a convex shape such as the jaw or portions of the face that are curved in a concave shape such as the area under the jaw, are shaved, the outer cutter 10 contacts the skin in a rectilinear configuration, and the outer cutter 10 only makes partial contact with the skin. As a result, hair must be shaved by moving the electric shaver back and forth for several times while changing the angle at which the outer cutter 10 contacts the skin. In such shaving, shaving stubble is formed, and shaving is in fact inefficient.

### SUMMARY OF THE INVENTION

The present invention is to solve the problems described above.

It is an object of the present invention to provide an easy-to-use reciprocating type electric shaver in which when curved portions of the face such as the jaw, neck, etc. are shaved, the outer cutter snugly contacts the skin in conformity with these curved portions, thus allowing efficient shaving by increasing the area of contact between the skin and the outer cutter, and eliminating the generation of the shaving stubble.

The above object is accomplished by a unique structure for a reciprocating type electric shaver that includes: an outer cutter, an inner cutter in which a plurality of cutter blades that make sliding contact with the inside surface of the outer cutter are provided on a cutter blade supporting body in a straight row in the direction of length of the outer cutter, and a driving mechanism that causes the inner cutter to make a reciprocating motion in the direction of length (or sideways) of the outer cutter; and in the present invention, the outer cutter is formed so as to be deformed into a curved shape such as a convex shape that protrudes outward or a concave shape that protrudes inward, etc., and the cutter blade supporting body is formed so as to be bent into a curved shape in conformity with the outer cutter.

In this structure of the present invention, the outer cutter deforms outwardly into a convex shape and inwardly into a concave shape, but the shape of the outer cutter under ordinary conditions (for example, when the shaver is not in use), is not restricted. When the outer cutter is in a convex or outwardly bent shape under ordinary conditions, then the shape of the top portion of this outer cutter is changed when the user changes the force that presses the shaver to the skin.

Furthermore, in the present invention, the action of a biasing element such as a spring that pushes the outer cutter outwardly or a compression spring that pulls the outer cutter inwardly is operated from the outside by an operating means such as an operating switch, etc. With this structure, the external shape of the outer cutter changes in accordance with the operation of such an operating means.

In the reciprocating type electric shaver of the present invention, the cutter blade supporting body is supported while being constantly urged in a direction that presses the outer cutter into a convex shape that protrudes outward. Accordingly, the outer cutter naturally bends in accordance with the shape of the shaving position on the face, etc. as a result of the adjustment of the pressing pressure with which the electric shaver is pressed against the skin, so that favorable shaving is accomplished.

In addition, in the reciprocating type electric shaver of the present invention, the cutter blade supporting body is provided via biasing elements such as a spring, etc. on the upper portion of the reciprocating drive shaft installed in the main body of the electric shaver and is also supported by biasing element provided between the cutter blade supporting body and the main body. Such biasing element between the cutter blade supporting body and the main body can be disposed on either. side of the reciprocating drive shaft.

Furthermore, in the reciprocating type electric shaver of the present invention, the cutter blade supporting body of the inner cutter is made of a shape memory material that possesses, at ordinary or room temperatures, an elasticity that assumes a curved shape in conformity with the curved shape of the outer cutter; and thus the outer cutter is variable in shape so that it assumes appropriate curved surface shape where the shaving is performed.

Furthermore, in the reciprocating type electric shaver of the present invention, the outer cutter is made of a film-form substrate that can expand and contract, and this substrate is provided with a plurality of ring-form cutter bodies whose undersurfaces that make sliding contact with the cutter blades are formed as cutting surfaces, and intermediate portions between the adjacent cutter bodies are formed into relief recessed portions.

### BRIEF DESCRIPTION OF THE DRAWINGS

FIG. 1(a) is a front view of the reciprocating type electric shaver according to one embodiment of the present invention, FIG. 1(b) showing the internal construction thereof (for supporting the cutter blade supporting body);

FIG. 2 shows the construction of the inner cutter and outer cutter that make sliding contact with each other;

FIG. 3 illustrates another structure for supporting the cutter blade supporting body;

FIG. 4 shows the overall construction of the outer cutter;

FIG. 5 is an enlarged sectional view of the outer cutter;

FIG. 6(a) shows a state in which an external force acts on the outer cutter, and FIG. 6(b) shows the internal structure thereof;

FIG. 7(a) shows another state in which an external force acts on the outer cutter and FIG. 7(b) shows the internal structure thereof;

FIGS. 8(a) through 8(c) show the manner of use of the reciprocating type electric shaver of the present invention is at different areas; and

FIG. 9(a) is a front view of a conventional reciprocating type electric shaver, and FIG. 9(b) illustrates the internal construction thereof.

### DETAILED DESCRIPTION OF THE INVENTION

Preferred embodiments of the present invention will be described in detail below.

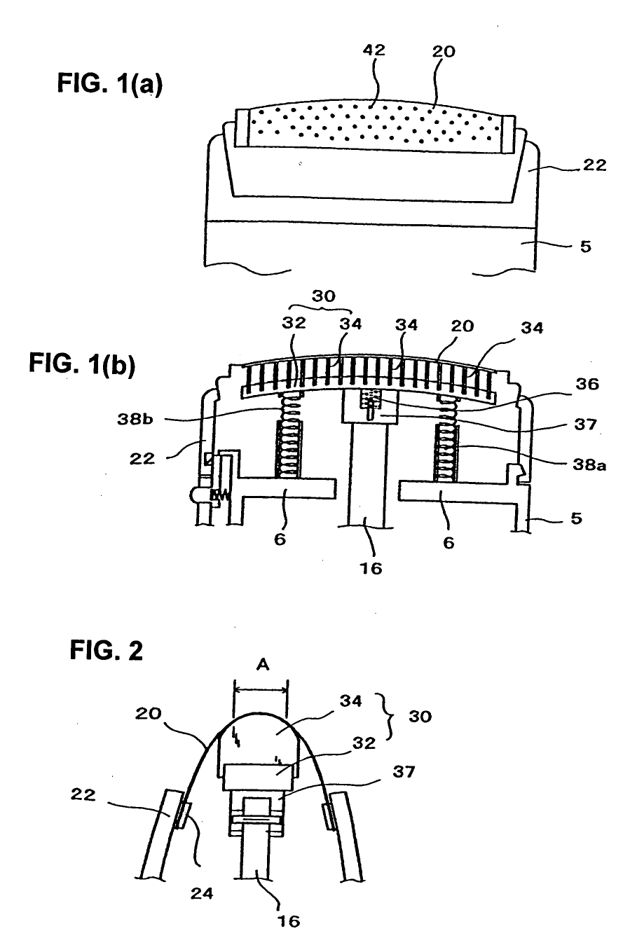

FIGS. 1(a) and 1 (b) show the structure of one embodiment of the reciprocating type electric shaver of the present invention, illustrating the inner and outer cutters that are the characterizing elements of the reciprocating type electric shaver of the present invention. FIG. 1(a) shows the external view of the outer cutter 20, and FIG. 1(b) shows the outer cutter 20 and inner cutter 30 in the interior of the electric shaver.

In FIGS. 1(a) and 1(b), no external force is acting on the outer cutter 20; and as seen from FIG. 1(a), in the shown embodiment of the present invention, the top portion of the outer cutter 20 is provided so as to bend outwardly or bend into a convex shape when no external force acts on the outer cutter 20.

In the reciprocating type electric shaver of the shown embodiment, the outer cutter 20 possesses elasticity (flexibility), so that the shape of the outer surface (top portion) of this outer cutter 20 can change. When no external force acts on the outer cutter 20, the top portion of the outer cutter 20 takes an outwardly protruding convex curved shape, and this shape results from the outer cutter 20 being pressed in the outward direction by the inner cutter 30. In other words, the outer cutter 20 assumes an outward-protruding convex curved shape by the pressing force of the inner cutter 30 that presses the outer cutter 20 outwardly.

As seen from FIG. 1 (b), the inner cutter 30 is comprised of a cutter blade supporting body 32 and cutter blades 34 disposed in a straight row at specified intervals on the cutter blade supporting body 32. As in the conventional reciprocating type electric shaver, the upper ends of the cutter blades 34 on which cutting edges are formed are formed in a circular arc shape (when viewed from the side, see FIG. 2), and these upper ends of the cutter blades 34 make sliding contact with the inside surface of the outer cutter 20.

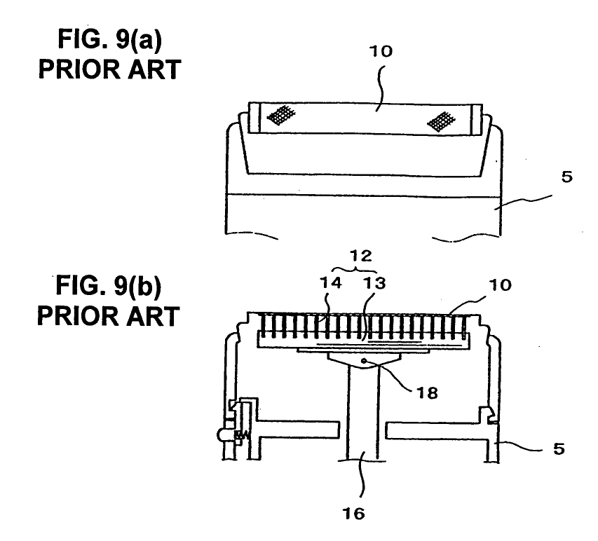

The structure of the inner cutter 30 is similar to that of the conventional inner cutter 12 shown in FIG. 9(b); however, in the shown embodiment of the present invention, the cutter blade supporting body 32 that supports the cutter blades 34 is formed by an elastic body, so that the cutter blade supporting body 32 is freely deformable into a concave or convex curved shape when seen from the front of the inner cutter (or deformable in a vertical direction in FIG. 1(b)). In FIG. 1(b), the cutter blade supporting body 32 is bent into a convex curved shape, thus protruding upward.

In order to allow the cutter blade supporting body 32 to bend or curved, the cutter blade supporting body 32 is provided so that this cutter blade supporting body 32 is constantly urged toward the outer cutter 20 by a spring 36 at the upper end of the reciprocating drive shaft 16. Furthermore, the cutter blade supporting body 32 is provided so that this cutter blade supporting body 32 is constantly urged, in positions located on both sides of the reciprocating drive shaft 16, toward the outer cutter 20 by springs 38a and 38b which are disposed between partition walls 6 of the main body 5 of the shaver and the undersurface of the cutter blade supporting body 32.

A slide member 37 which is engaged with the upper end of the reciprocating drive shaft 16 and slides in the axial direction of the reciprocating drive shaft 16 (in the vertical direction in FIG. 1(b)) is attached to the undersurface of the center (with respect to the direction of length) of the cutter blade supporting body 32. The spring 36 is mounted between the reciprocating drive shaft 16 and the slide member 37 and supports the cutter blade supporting body 32 so that this cutter blade supporting body 32 is pushed away from the reciprocating drive shaft 16. The slide member 37 is supported so as to be movable in the axial direction (or in a vertical direction in FIG. 1(b)) of the reciprocating drive shaft 16 and to be tiltable with respect to the reciprocating drive shaft 16. The structure that allows the slide member 37 to be thus movable and tiltable with respect to the reciprocating drive shaft 16 is attained by way of, for instance, forming a slot in the slide member 37 and engaging a shaft fastened to the reciprocating drive shaft 16 with this slot. Of course, the manner of engagement between the slide member 37 and the reciprocating drive shaft 16 is not limited to the manner described above.

The reciprocating drive shaft 16 is driven to reciprocate in the direction of length of the outer cutter 20 (or in the horizontal direction in FIG. 1(b)) by a driving mechanism (not shown) such as a driving motor, etc. that is provided in the main body of the shaver.

Thus, as seen from FIG. 1(b), as a result of the springs 36, 38a and 38b, the cutter blade supporting body 32 acts via the cutter blades 34 so that the outer cutter 20 is caused to protrude outward, so that the outer cutter 20 takes a curved shape in which the central portion of the top portion protrudes outward. Since the springs 36, 38a and 38b act to press the cutter blade supporting body 32 into a curved shape, the elastic pressing force of the springs 36, 38a and 38b is set so that this force exceeds the elastic recovery force of the cutter blade supporting body 32. The reason for this is that if the elastic recovery force of the cutter blade supporting body 32 exceeds the elastic force of the springs 36, 38a and 38b, the cutter blade supporting body 32 cannot bend into a curved shape as shown in FIG. 1(b).

For the biasing means or the springs 36, 38a and 38b, springs that have a specified elastic force so that the top portion of the outer cutter 20 protrudes in a curved shape are selected.

FIG. 2 shows the side of the outer cutter 20 being pushed upward by the inner cutter 30.

The upper ends of the cutter blades 34 of the inner cutter 30 are formed in a circular arc shape (i.e., a circular arc shape that protrudes upward), and the upper ends of the cutter blades 34 are in contact with the inside surface of the outer cutter 20 so that the outer cutter 20 is pushed out into a convex shape that conforms to the shape of the upper ends of the cutter blades 34. In other words, the inner cutter 30 overcomes the action of the outer cutter 20 whereby the outer cutter 20 tends to drop and keeps pushing the outer cutter 20 upward, so that the top portion of the outer cutter 20 forms a convex curved surface. The reference symbol A in FIG. 2 indicates an area where the upper ends of the cutter blades 34 of the inner cutter 30 and the outer cutter 20 make contact.

Since the cutter blades 34 are formed in a straight row at specified intervals on the inner cutter 30 (in the direction of length of the outer cutter 20 or a horizontal direction), the outer cutter 20 as a whole is supported so as to take a smooth curved surface shape. The reference numeral 22 in FIG. 2(b) indicates an outer cutter unit casing which is detachably mounted on the main body of the electric shaver, and 24 indicates anchoring portions where the outer cutter 20 is fixed to the inside surface of the casing 22.

The manner for supporting the inner cutter 30 so that the inner cutter 30 can deform into a curved shape as described above is not limited to that of the above-described embodiment. In the above, respective single springs 38a and 38b are installed in symmetrical positions on both sides of the reciprocating drive shaft 16; however, a plurality of springs can be installed in each of these positions, and the installation positions of the springs are not limited to such symmetrical positions but can be properly selected.

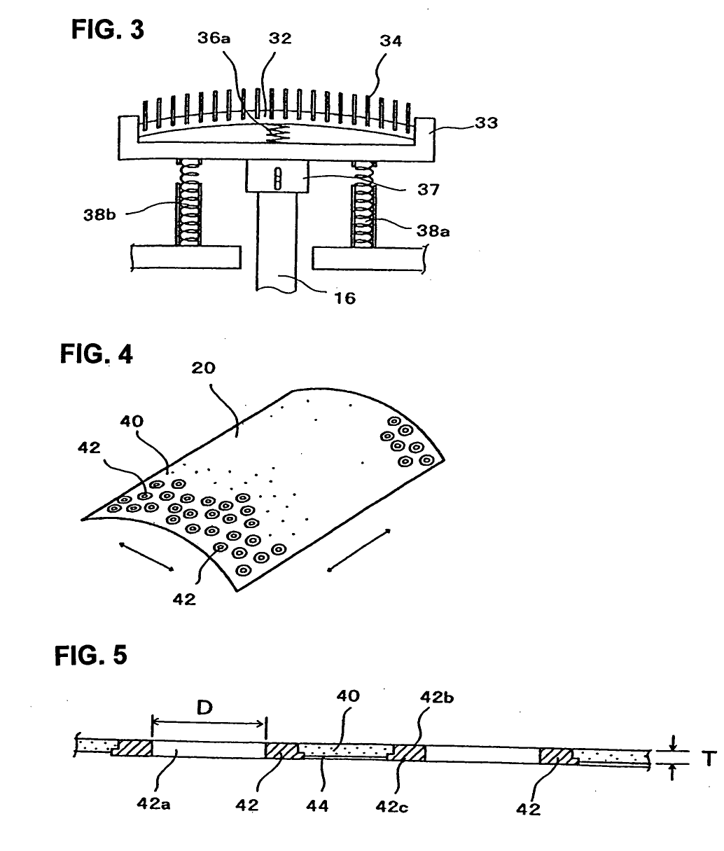

FIG. 3 shows another example of a structure for supporting the cutter blade supporting body 32 in a curved or deformed fashion. In FIG. 3, the reference numeral 33 is a supporting plate that holds the cutter blade supporting body 32. The supporting plate 33 is formed from a material that has a rigidity which is free of deformation such as bending.

In the structure of FIG. 3, springs 38a and 38b are used so that they support the supporting plate 33 in a manner that allows rising and lowering (or floating) of the outer cutter 20. A spring 36a is provided between the cutter blade supporting body 32 and the supporting plate 33. The spring 36a pushes the cutter blade supporting body 32 and supporting plate 33 apart. In this embodiment, the spring 36a causes bending of the cutter blade supporting body 32. Both ends of the cutter blade supporting body 32 are provided so that the cutter blade supporting body 32 is separated from the bottom surface of the supporting plate 33, and the cutter blade supporting body 32 bends into a shape that protrudes upward or a shape that protrudes downward with respect to the supporting plate 33.

In the structure of FIG. 3, the outer cutter 20 takes a compounded action in which the outer cutter 20 is raised and lowered by “floating” action caused by the springs 38a and 28b and is also deformed into a curved shape by the bending deformation of the cutter blade supporting body 32 caused by the spring 36a.

Under ordinary conditions (for example, when the shaver is not in use), the cutter blade supporting body 32 of the embodiment of FIG. 3 takes an outwardly bent shape. This cutter blade supporting body 32 is manufactured using a shape memory material such as a shape memory alloy, etc., so that the cutter blade supporting body 32 memorizes such a shape that protrudes upward at ordinary temperature. In other words, the cutter blade supporting body 32 is formed so that it takes a shape that protrudes upward at ordinary temperature and has an elasticity that allows deformation into a specified curved shape, and the thus obtained cutter blade supporting body 32 is provided on the reciprocating drive shaft 16. With this cutter blade supporting body 32 made of a shape memory material, the outer cutter 20 can be deformed into a curved shape without using the springs 36, 38a, 38b, etc. Of course, a combination of the cutter blade supporting body 32 made of a shape memory material and springs that cause a bending action or springs that cause the floating can be employed.

In the outer cutter 20 of the reciprocating type electric shaver of the present invention, its outer surface shape can assume an arbitrary shape such as a curved surface that protrudes upward or a curved surface that protrudes downward. FIGS. 4 and 5 show an example of the outer cutter that has expansion and contraction properties (flexibility) that allow such variations in the outer surface shape.

FIG. 4 shows the outer cutter 20 spread into a flat shape, and FIG. 5 shows the sectional view of the outer cutter 20. In this outer cutter 20, cutter bodies 42 formed in a ring-form shape are provided on a substrate 40 formed as a film that can expand and contract. The cutter bodies 42 cut hair between the cutter bodies 42 and the cutter blades 34 of the inner cutter 30, and the inside surfaces (undersurfaces) that make sliding contact with the cutter blades 34 constitute cutting surfaces. The reason that the substrate 40 that is formed from a material that can expand and contract is used is to allow free expansion and contraction of the outer cutter 20 in arbitrary directions such as the longitudinal and lateral directions or oblique directions, etc.

As shown in FIG. 5, in the outer cutter 20, adjacent cutter bodies 42 are connected by the substrate 40. The expansion and contraction of the outer cutter 20 is generated by the expansion and contraction of the substrate 40 that has the cutter bodies 42 thereon.

The thickness T of the outer cutter 20 is approximately 0.05 mm, and the hole diameter D of the hole 42a in each of the cutter bodies 42 is approximately 0.6 mm. In other words, the outer cutter 20 is thinner than the diameter dimension of the cutter bodies 42. In order to form the outer surface of the outer cutter 20 that contacts the skin as a smooth surface, the outer surfaces 42b of the cutter bodies 42 and the outer surface of the substrate 40 are formed flush or on the same plane in the height direction. In regard to the inside surfaces of the cutter bodies 42, the undersurfaces 42c of the cutter bodies 42 protrude slightly beyond the inside surface of the substrate 40, so that relief recessed portions 44 are formed between the undersurfaces 42c of the cutter bodies 42 and the substrate 40.

These relief recessed portions 44 are formed to prevent the cutter blades 34 of the inner cutter 30 from contacting the substrate 40 when the inner cutter 30 makes a reciprocating motion on the inside of the outer cutter 20. In an outer cutter formed by an electro-casting process as well, the relief recessed portions 44 are formed as countersinks. The cutters of the cutter blades 34 and the cutter bodies 42 rub against each other with the undersurfaces 42c of the cutter bodies 42 as rubbing surfaces. Since numerous cutter bodies 42 are disposed at very small intervals in between in a zigzag pattern, etc., the respective cutter blades 34 always make sliding contact with some of the cutter bodies 42 regardless of the movement position of the inner cutter 30. Accordingly, with the relief recessed portions 44, the cutter blades 34 of the inner cutter 30 will not contact the substrate 40 when the inner cutter 30 makes a reciprocating motion.

Thus, since the outer cutter 20 is expandable and contractable, and since cutter bodies 42 formed in a ring-form shape are disposed on the outer cutter 20, hair is introduced via the holes 42a of the cutter bodies 42 and is cut by the cooperative action of the cutter bodies 42 and the inner cutter 30.

The outer cutter 20 is formed by, for instance, a method in which the cutter bodies 42 are insert-molded using a resin material which can expand and contract or which possesses flexibility or by a method in which setting holes in which the cutter bodies 42 are set are formed in the substrate 40, and the cutter bodies 42 are respectively inserted into these setting holes. As seen from FIG. 5, it is also possible to regulate the end surface positions on the outer surface side of the cutter bodies 42 by forming flanges around the circumferential edges on the inner surface sides of the cutter bodies 42.

In cases where a material that has specific expansion and contraction properties or flexibility and durability against rubbing with the inner cutter 30 is selected for the outer cutter 20, the outer cutter 20 itself can be formed using such a material.

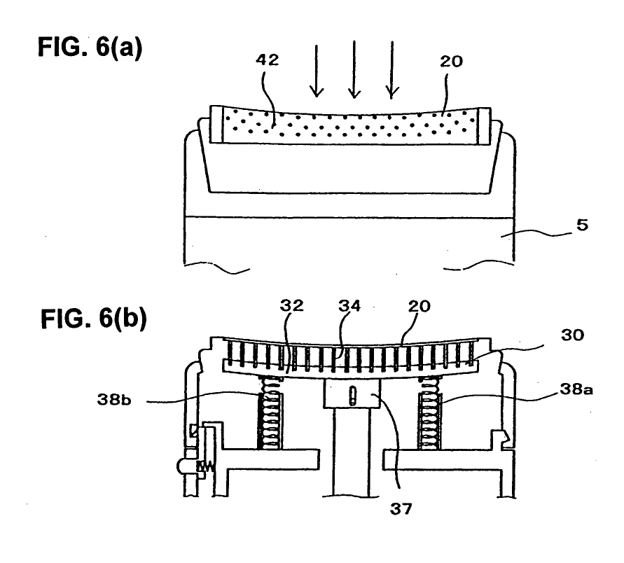

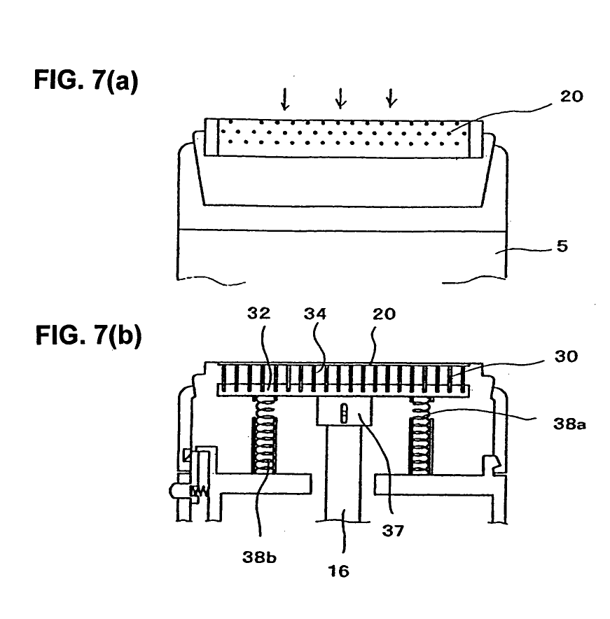

Shown in FIGS. 1(a) and 1(b) is a state in which no external force is acting on the outer cutter 20, and therefore, the top portion of the outer cutter 20 is in a curved shape so that this top portion protrudes outward. FIGS. 6(a) and 6(b) and FIGS. 7(a) and 7(b) show states in which an external force is acting on the outer cutter 20.

In FIGS. 6(a) and 6(b), the top portion of the outer cutter 20 is bent into a shape that protrudes downward in a case where an external force that presses the outer cutter 20 from the outside is applied. In this case, as shown in FIG. 6(b), the slide member 37 is pushed downward as a result of the outer cutter being pushed downward, so that the cutter blade supporting body 32 also assumes a shape that is bent downward in the same manner as the shape of the outer cutter 20.

FIGS. 7(a) and 7(b) show the case in which the force that presses the outer cutter 20 from the outside is weaker than the force in the case of FIGS. 6(a) and 6(b), and as a result, the top portion of the outer cutter 20 takes a substantially rectilinear or straight shape. In conformity with the shape of the outer cutter 20, the cutter blade supporting body 32 also takes a substantially rectilinear shape. In this state, the slide member 37 on the reciprocating drive shaft 16 is in an intermediate position with respect to the vertical direction in FIG. 7(b).

In the reciprocating type electric shaver of the shown embodiment, the inner cutter 30 makes a reciprocating motion in the direction of length (or in the horizontal or lateral direction) of the outer cutter 20 while making sliding contact with the inside surface of the outer cutter 20 in which the outer cutter 20 is in a curved shape, thus performing the shaving. Such an action is made possible by the fact that the outer cutter 20 is provided in a state in which the outer cutter 20 and cutter blades 34 of the inner cutter 30 constantly rub against each other, and by the fact that the cutter blade supporting body 32 can easily deform into a curved shape, so that deformation in conformity with the shape of the outer cutter 20 or in conformity with the deformation of the outer cutter 20 is possible.

Thus, in the reciprocating type electric shaver of the present invention, since the outer surface shape of the outer cutter 20 varies in accordance with the external force that acts on the outer cutter 20, the shape of the outer cutter 20 changes in accordance with the shaving position such as the cheeks, jaw or area under the jaw, etc., so that reliable shaving is performed on any shaving areas.

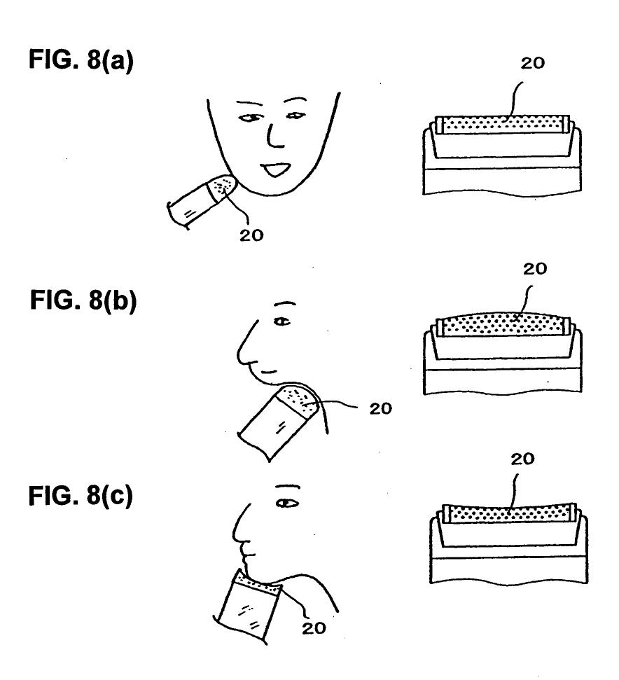

FIGS. 8(a) through 8(b) show how the configuration of the outer cutter 20 of the reciprocating type electric shaver varies according to the shaving position.

FIG. 8(a) shows a state in which the cheeks are being shaved. Since the skin is flat, the shaver is used so that the outer cutter 20 is pressed slightly against the skin. As a result, the top portion of the outer cutter 20 takes a rectilinear or straight shape, and flat portions of the face are suitably shaved. FIG. 8(b) shows the manner of shaving of the area under the jaw. Since the area under the jaw is concave, shaving is performed without applying any force to the outer cutter 20. As a result, the outer cutter 20 bends and in an outwardly protruded shape, thus making it possible to shave this concave area in a suitable manner. FIG. 8(c) shows that the jaw area is shaved. Since the jaw area protrudes outward, shaving is performed with a force applied to the outer cutter 20, so that the outer cutter 20 is caused to bend inward, thus allowing shaving to be performed with the outer cutter 20 in a configuration that conforms to the shape of the jaw.

In the reciprocating type electric shaver of the shown embodiment, since shaving is performed with the outer cutter fitting on the skin, the contact area between the skin and the outer cutter increases, and hair is efficiently shaved. Furthermore, since the skin and outer cutter are easily and snugly fitted to each other, hair is reliably shaved without leaving any shaving stubble.

In the above-description, the reciprocating type electric shaver has a single outer cutter 20 (and a corresponding single inner cutter). However, the above-described construction of the cutter blade supporting body and outer cutter, etc. is applicable to a reciprocating type electric shaver that has two or more outer cutters 20 (and corresponding number of inner cutters) installed parallel to each other. In the case of such an electric shaver as well, the outer cutters bend by the action of an external force on the outer cutters, so that shaving that is suited to the shaving position on the face can be performed in the same manner as in the above-described embodiment. In an electric shaver in which two outer (and inner) cutters are installed, the shaver can be designed so that the deformation (bending) of the two outer cutters occurs in the same direction simultaneously and so that one outer cutter bends outward and the other outer cutter(s) bends inward.

Furthermore, the structure of the present invention in which the external shape of an outer cutter(s) is made variable is applicable to rotary type electric shavers equipped with dome-shaped outer cutters. In such rotary type electric shavers equipped with dome-shaped outer cutters as well, the outer cutters are formed from an expandable material, etc. so that the outer cutters can take a convex or concave shape, and two inner cutters are concentrically provided on the inner circumferential side and outer circumferential side so that these two inner cutters on the inner circumferential side and outer circumferential side are respectively movable in the axial direction by biasing elements, etc. In such a structure, shaving is performed with the outer cutters deformed into curved surfaces such as center-symmetrical convex or concave shapes, etc.

As seen from the above, according to the present invention, in a reciprocating type electric shaver, the outer cutter is deformable into a curved surface shape such as a convex shape that protrudes outward or a concave shape that protrudes inward, and the inner cutter is bent along with the outer cutter. Accordingly, shaving is performed by varying the shape of the outer cutter in accordance with the shaving positions on the face. As a result, the reciprocating type electric shaver of the present invention allows efficient shaving and has a good shaving capability that leaves no shaving stubble, etc.

1. A reciprocating type electric shaver comprising:
an outer cutter,
an inner cutter in which a plurality of cutter blades that make sliding contact with an inside surface of said outer cutter are provided on a cutter blade supporting body in a straight row in a direction of length of said outer cutter, and
a driving mechanism that causes said inner cutter to make a reciprocating motion in said direction of length of said outer cutter; wherein
said outer cutter is deformable to take an outwardly curved shape or an inwardly curved shape, and
said cutter blade supporting body of said inner cutter is formed to bend into a curved shape in conformity with said outer cutter.

2. The reciprocating type electric shaver according to claim 1, wherein said cutter blade supporting body of said inner cutter is provided while being constantly urged in a direction that presses said outer cutter into an outwardly curved shape.

3. The reciprocating type electric shaver according to claim 2, wherein said cutter blade supporting body is provided via a biasing element on an upper portion of a reciprocating drive shaft installed in a main body of said electric shaver and is supported by a biasing element provided between said cutter blade supporting body and said main body.

4. The reciprocating type electric shaver according to claim 1, 2 or 3, wherein said cutter blade supporting body is made of a shape memory material that takes at ordinary temperature a curved shape in conformity with a curved shape of said outer cutter and has an elasticity that provides curved deformation.

5. The reciprocating type electric shaver according to claim 1, wherein said outer cutter is made of a film-form substrate that is expandable and contractable, and said substrate is provided with a plurality of ring-form cutter bodies and relief recessed portions disposed between said ring-form cutter bodies., undersurfaces of said ring-form cutter bodies that make sliding contact with said cutter blades being formed as cutting surfaces.
